(19) United States
(12) Patent Application Publication
(10) Pub. No.: US 2026/0359304 A1
(43) Pub. Date: Nov. 12, 2026

(54) SYSTEM AND METHOD FOR GENERATING COMPLETE AND CONTEXTUALLY ACCURATE RESPONSES USING HIERARCHICAL DOCUMENT CHUNKING AND RETRIEVAL

(71) Applicant: Genpact USA, Inc., New York, NY (US)

(72) Inventors: Sachin Arora, Gurgaon (IN); Shubhro Pal, Gurgaon (IN); Nitin Vedprakash Agarwal, Bangalore (IN)

(21) Appl. No.: 19/202,635

(22) Filed: May 8, 2025

(51) Int. Cl. G06F 16/2457; G06F 16/242; G06F 16/2453; G06F 16/93

(52) U.S. Cl. CPC G06F 16/24575; G06F 16/243; G06F 16/24534; G06F 16/93

(57) ABSTRACT

According to an aspect of the present disclosure, a computer-implemented method for generating complete and contextually accurate responses in a retrieval-augmented generation system using a pretrained generative artificial intelligence (AI) model is presented. A method may include modifying the query based on a determined relevance. A method may include parsing a plurality of electronic documents to identify hierarchical structures of each electronic document of the plurality of electronic documents. A method may include converting the hierarchical structures into one or more data chunks based on content within the hierarchical structures. A method may include retrieving one or more of the data chunks based on the modified query. A method may include receiving as output from the pretrained generative AI model a response based at least in part on the modified query and the retrieved one or more data chunks.

### BACKGROUND

In the field of information retrieval and artificial intelligence (AI), providing users with accurate and comprehensive responses to queries is of paramount importance. Existing retrieval-augmented generation (RAG) systems, especially those employing generative AI technologies, often fall short in delivering complete answers.

### SUMMARY

According to an aspect of the present disclosure, a computer-implemented method for generating complete and contextually accurate responses in a retrieval-augmented generation system using a pretrained generative artificial intelligence (AI) model is presented. A method may include receiving a query associated with a user. A method may include determining a context of the query based on a prior conversational history of the user with the pretrained generative AI model. A method may include determining a relevance of the query to a current conversation of the user with the pretrained generative AI model based on the context of the query. A method may include modifying the query based on the determined relevance. A method may include parsing a plurality of electronic documents to identify hierarchical structures of each electronic document of the plurality of electronic documents. A method may include converting the hierarchical structures into one or more data chunks based on content within the hierarchical structures. A method may include retrieving one or more of the data chunks based on the modified query. A method may include providing the modified query and the retrieved one or more data chunks as input to the pretrained generative AI model. A method may include receiving as output from the pretrained generative AI model a response based at least in part on the modified query and the retrieved one or more data chunks.

According to an aspect of the present disclosure, An apparatus for generative artificial intelligence (AI) query processing is presented. An apparatus may include a processor and a memory communicatively coupled to the processor, the memory containing instructions configuring the processor to perform various operations. A processor may be configured to receive a query associated with a user. A processor may be configured to modify the query through one or more of rectification and expansion of the query to provide a corrected query. A processor may be configured to determine a context of the corrected query based on a prior conversational history of the user with a pretrained generative AI model. A processor may be configured to determine a relevance of the corrected query to a current conversation of the user with the pretrained generative AI model based on the context of the corrected query. A processor may be configured to adapt the corrected query based on the determined relevance. A processor may be configured to parse a plurality of electronic documents to identify hierarchical structures of each electronic document of the plurality of electronic documents. A processor may be configured to convert the hierarchical structures into one or more data chunks based on content within the hierarchical structures. A processor may be configured to retrieve one or more of the data chunks based on the modified query. A processor may be configured to provide the corrected query and the retrieved one or more data chunks as input to the pretrained generative AI model.

According to an aspect of the present disclosure, a system for data retrieval in a generative artificial intelligence (gen AI) model is presented. A system may include a computing device. A computing device may be configured to receive a plurality of documents. A computing device may be configured to parse the plurality of documents to identify hierarchical structures of each document of the plurality of documents. A computing device may be configured to convert the hierarchical structures into one or more data chunks based on content of the identified hierarchical structures. A computing device may be configured to retrieve, based on a query, the one or more data chunks. A computing device may be configured to provide the retrieved one or more data chunks as input to a pretrained gen AI model.

### BRIEF DESCRIPTION OF THE DRAWINGS

The subject matter of the present disclosure will be explained in more detail in the following text with reference to preferred exemplary and non-limiting embodiments which are illustrated in the attached drawings.

FIGS. 1A-B illustrate a system architecture;

FIG. 2 illustrates an embodiment of query processing;

FIG. 3 illustrates an embodiment of generating a response with a prompt template;

FIG. 4 illustrates another embodiment of generating a response with a prompt template;

FIG. 5 illustrates a flowchart of an embodiment of data chunking;

FIG. 6 illustrates another flowchart of an embodiment of data chunking;

FIGS. 7A-B illustrate data chunked documents;

FIG. 8 illustrates a retrieval process;

FIG. 9 illustrates a hybrid retrieval process;

FIG. 10 illustrates a flowchart for dynamic example generation;

FIG. 11 illustrates a flowchart for a method of generating complete and accurate responses using a gen AI model;

FIG. 12 illustrates a block diagram of a machine learning module that may be used with systems and computing devices described throughout this disclosure; and

FIG. 13 illustrates a computing environment.

These figures disclose embodiments of the present disclosure for illustrational purposes only. In particular, the disclosure provided by the figures and description is not meant to limit the scope of protection conferred by the present disclosure.

### DETAILED DESCRIPTION

These figures disclose embodiments of the present disclosure for illustrational purposes only. In particular, the disclosure provided by the figures and description is not meant to limit the scope of protection conferred by the present disclosure.

### Overview

At a high level, aspects of the present disclosure provide for improved response generation in the field of generative artificial intelligence (gen AI), large language models (LLMs), or other artificial intelligences (AI). Often times, responses generated by standard LLMs may give partial responses. For instance, current systems may provide incomplete answers, omitting critical information that does not directly match a query but is otherwise essential for comprehensive understanding. Further, with standard LLMs, there is a risk of omission in generating responses. Omission of information may cause an incomplete or inaccurate response generated from an LLM. Moreover, with standard LLM s, data break down and retrieval typically works arbitrarily, based on paragraphs or pages breaks, which can lead to disjointed data representation. In view of these challenges, the present disclosure provides a prompt generation process that improves accuracy, comprehensiveness, and context awareness of LLMs.

In some embodiments, systems and processes described herein may provide for a hierarchical structure preservation, where documents may be parsed to identify headers and/or subleaders, assigning levels based on numbering, indentation, and/or font size. A hierarchical path may be embedded with each data chunk's metadata of a plurality of data chunks.

Embodiments of the present disclosure may provide for advanced multi-step retrieval processes. For instance, systems and processes described herein may retrieve initial data chunks based on cosine similarity and may re-rank data chunk using a model to select most relevant data chunks. Systems and processes described herein may provide for more complete context retrieval. For instance, selected data chunks may have header paths identified, and data chunks with similar header paths may be determined to be related and/or retrieved. Therefore, the present disclosure provides improvements to LLM technology, including increasing response generation efficiency, accuracy, and comprehensiveness.

### System Architecture

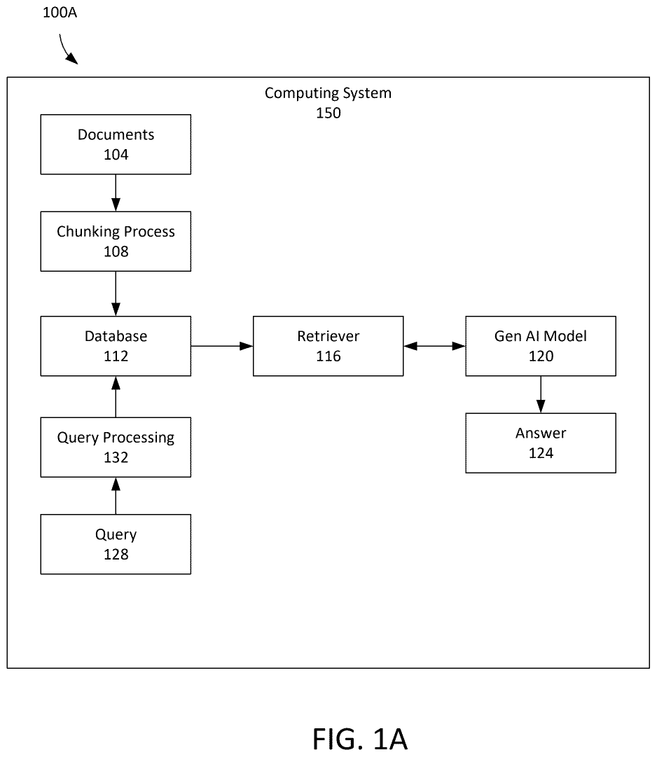

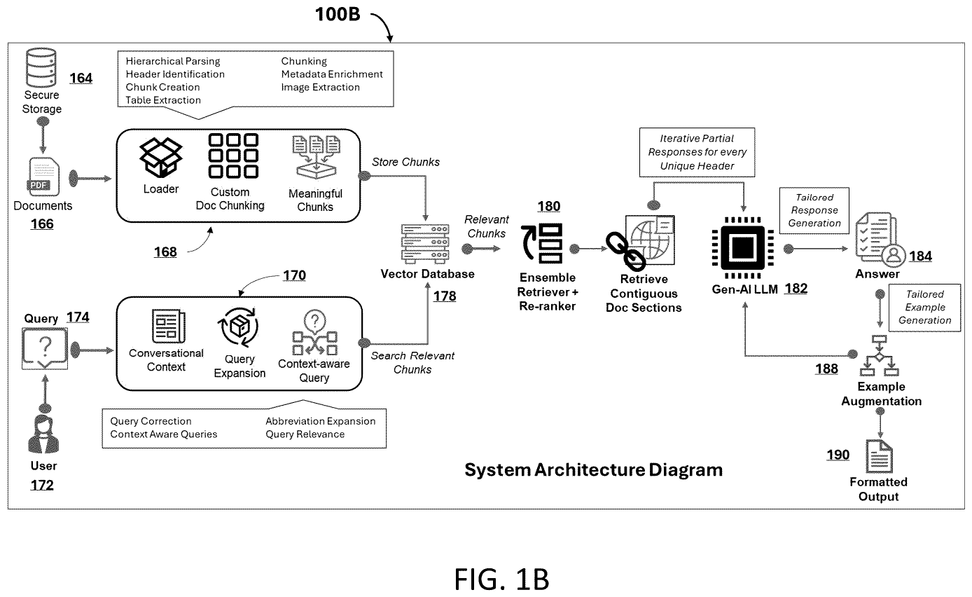

Referring now to FIG. 1A, a system architecture 100A is presented. System 100A may be used to generate complete and accurate responses using a generative artificial intelligence (gen AI) model. System 100 may include computing system 150. Computing system 150 may include one or more processors, memories, and/or other devices. In some embodiments, computing system 150 include one or more computing devices, such as, but not limited to, laptops, desktops, servers, or other computing devices. Computing system 150 may operate in a local area network (LAN), cloud-based network, or other network. In some embodiments, computing system 150 may be configured to receive one or more documents 104. Computing system 150 may retrieve one or more documents 104 from one or more databases. In some embodiments, computing system 150 may receive one or more documents 104 from one or more computing devices, such as through a wired or wireless connection. Documents 104 may be, but are not limited to, text documents, presentations, spreadsheet files, PD Fs, JPEGs, or any other type of document. Content of documents 104 may include various fonts, headers, spacing, numbering, coloring, indentations, characters, numbers, symbols, textual strings, and/or other document data. In some embodiments, a document of documents 104 may be two or more pages long. A document of documents 104 may be a combination of, but is not limited to, a textual characters, images, symbols, and/or any other document data.

Computing system 150 may be configured to perform chunking process 108 with one or more documents 104. A “chunking process” as used in this disclosure refers to an operation in which one or more documents are broken down into one or more data chunks. A “data chunk” as used in this disclosure refers to a sub-portion of a document. Chunking process 108 may include identifying one or more headers of one or more documents 104. “Headers” refer to textual information that denotes a context or theme of following content. Headers may be displayed at a top of a page of a document, a middle of a page of a document, and/or any other location of a document. In some embodiments, headers may be identified through the use of an LLM, through optical character recognition (OCR), image processing, or a combination thereof. Chunking process 108 may include assigning a level to one or more headers in a hierarchical structure. A “hierarchical structure” refers to ranked system of data with respect to overall importance. A level may be representative of an overall importance of a header and/or content relating to the header. For instance, and without limitation, headers may be assigned levels from 0 to N (e.g., N=3, N=5, N=10, and so on), with 0 representing a header having a highest significance with respect to content of a document which would often be the title of the document. In some embodiments one or more inner or sub-headers may assume sequentially higher numbers signifying a depth of a document header hierarchy. In some embodiments, a single document of documents 104 may have multiple headers, such as two or more headers. Two or more headers of a single document of documents 104 may be assigned various levels, such as anywhere between 0 to 5 or greater. In some embodiments, headers are assigned levels sequentially. For instance, a first header in a document may be assigned a level of “0”, while a next subsequent header in a document may be assigned a level of “1” and so on. In some embodiments, if a subsequent header is found be a sub-header or inner header then its level number would be one higher than its prior header. In some embodiments, if a subsequent header is at the level of its parent header, then its level number is one lower than the header. In some embodiments, if a subsequent header is at a same level as a header then its level number will match the header level number. In some embodiments, chunking process 108 includes identifying sub-headers. “Sub-headers” refer to textual data denoting portions of content following a header. For instance, a document may have a first header that may indicate content within the document, and one or more sub-headers following the header that may indicate portions of the content specific to the sub-header. Sub-headers may be assigned levels from 0 to N (e.g., N=3, N=5, N=10, and so on). In some embodiments, chunking process 108 assigns one or more levels to one or more sub-headers separately from main headers of documents 104. In other embodiments, one or more sub-headers of documents 104 may be grouped together during assignment of levels of chunking process 108. As a non-limiting example, a first header of a document may be assigned a level of “0”, while a sub-header of the first header may be assigned a level of “1”. In some embodiments, sub-headers may be linked to one or more parent headers and/or subsequent child headers may be linked to the one or more sub-headers. In some embodiments, headers may be linked together as a chain. A chain of headers may include at least two headers and/or sub-headers. In some embodiments, chunking process 108 may include performing a boundary analysis on one or more documents 104 to identify relevant images, tables, and/or graphs. Chunking process 108 may include converting one or more images into text, in some embodiments.

Still referring to FIG. 1, chunking process 108 may include generating one or more data chunks from one or more documents of documents 104. Data chunks may include, but are not limited to, text, tables, images, and/or other content. Data chunks may be generated based on an assignment of levels of one or more headers of documents 104. Data chunks may be one or more portions of one or more documents 104 that may have a relationship with one another. For instance, a first data chunk and a second data chunk may originate from a same document. In some embodiments, chunking process 108 may include embedding an assignment of one or more levels into metadata of a data chunk. By embedding level assignments into metadata of data chunks, a hierarchical structure of data of the data chunks may be preserved, which may enable more efficient and relevant retrieval of one or more data chunks.

In some embodiments, system 100 includes database 112. Database 112 may be any suitable form of database, without limitation. In some embodiments, database 112 may be a vector database. In other embodiments, database 112 may be a Facebook Artificial Intelligence Similarity Search (FAISS) index. One or more data chunks resulting from chunking process 108 may be stored in database 112. Data of database 112 may be retrieved by retriever 116. In some embodiments, retriever 116 may retrieve data from database 112 for use with gen AI model 120, as described in further detail below.

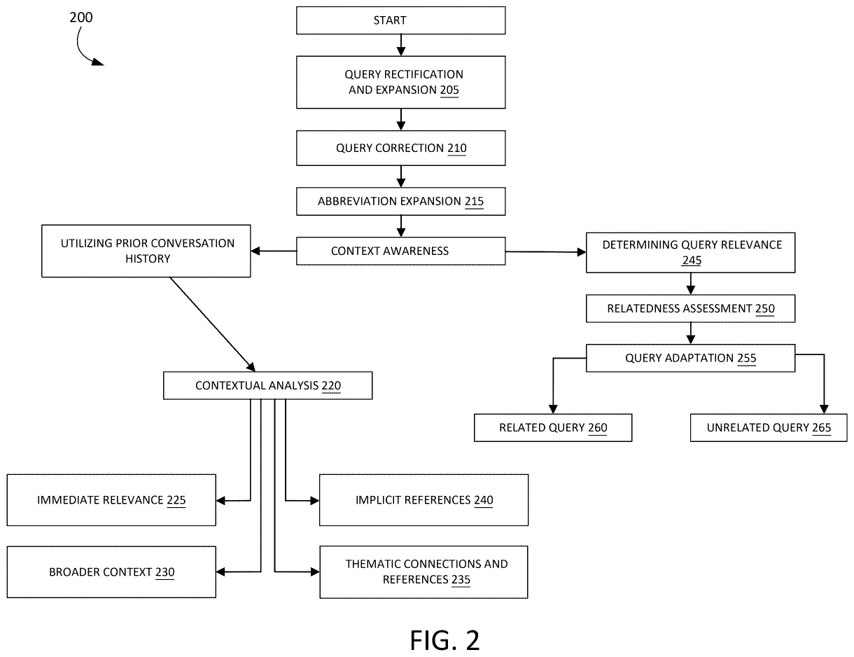

In some embodiments, computing system 150 may receive query 128 from a user. A “query” as used in this disclosure refers to a textual input to which an artificial intelligence may generate a response. Query 128 may be in the form of a question, in some embodiments. Computing system 150 may modify query 128 through query processing 132. “Query processing” refers to an operation of adjusting a query based on a set of criteria. Criteria may include, but are not limited to, abbreviation restrictions, typographical error restrictions, context expansiveness, and/or other criteria. In some embodiments, query processing 132 includes correcting grammatical and/or typographical errors of query 128. Query processing 132 may include expanding abbreviations of query 128 to full length forms. In some embodiments, query processing 132 may include determining context awareness of query 128. “Context awareness” refers to a relevance of a query with respect to one or more prior conversational histories. Query processing 132 may include performing a contextual analysis of query 128. A contextual analysis of query 128 may include determining an immediate relevance, broader context, thematic connections and/or references, and/or implicit references, as described in further detail below with reference to FIG. 2.

Query processing 132 may include determining an overall relevance of query 128 with respect to an immediate conversation with gen AI model 120. For instance, query processing 132 may determine if query 128 is relevant to a prior query input into gen AI model 120. If query 128 is determined to be related to an immediate conversation with gen AI model 120, query processing 132 may include adapting query 128 to expand on relevant context. For instance, query processing 132 may adapt query 128 to include data from one or more previous queries input into gen AI model 120 and/or responses generated by gen AI model 120. If query 128 is determined via query processing 132 to be unrelated to an immediate conversation, query 128 may be treated as an entirely new query by gen AI model 120, which may avoid cross-over of unrelated information in responding to an unrelated query 128. Query processing 132 may output a “modified” or “adapted” query 128, each term used interchangeably herein. Query 128 may be adapted by query processing 132 to fit a determined relevance for input into gen AI model 120. A relevance may be determined by comparing query 128 with one or more previous conversational histories with gen AI model 120. For instance, query 128 may be expanded to include additional context from database 112. Query processing 132 is described in further detail below with reference to FIG. 2.

With continued reference to FIG. 1, system 100 may include retriever 116. Retriever 116 may be software programmed to retrieve data from database 112. In some embodiments, retriever 116 may retrieve one or more data chunks from database 112 and/or one or more queries 128 from database 112. Retriever 116 may retrieve one or more data chunks based on query 128. In some embodiments, query 128 may be embedded into a vector of database 112 and may be represented as a vector within database 112. Retriever 116 may perform a semantic search function using a vector database index. For instance, retriever 116 may compare query 128 and/or a vector of query 128 with one or more other vectors within database 112. Other vectors may include data chunks, in some embodiments. Retriever 116 may perform a keyword search of database 112. For instance, retriever 116 may perform a search using the best matching 25 (BM 25) function. Retriever 116 may retrieve one or more data chunks of database 112 based on a ranked keyword such, such as, but not limited to, a BM 25 function.

Retriever 116 may perform a hybrid search, using both a semantic search and a keyword search. A hybrid search may include performing both a semantic search and a keyword search in parallel. A hybrid search may include performing a semantic search and a keyword search in series. For instance, a keyword search may be performed initially, while a semantic search may be performed subsequently to a keyword search. In some embodiments, results of a keyword search may be used to perform a semantic search, and vice versa. By utilizing both a keyword and semantic search, accurate and relevant data may be retrieved from database 112 regardless of a semantic or keyword style input received from a user via query 128. In some embodiments, query 128 may include a combination of keywords, semantic, or other forms of inquiries, which may be identified by gen AI model 120 and used by retriever 116 to retrieve relevant and accurate data.

In some embodiments, retriever 116 may consolidate one or more results of a search performed within database 112. One or more results may be applied a weightage. A “weightage” as used in this disclosure refers to a numerical value assigning an overall importance of data to a function. Weightage may be applied from 0 to 1, with 0 being the least important and 1 being the most important. In some embodiments, retriever 116 may consolidate results of a hybrid search, such as both a semantic search and a keyword search. Retriever 116 may apply a higher weightage to results of a semantic search and a lesser weight to results of a keyword search, which may give priority to semantic relevance while incorporating keyword matches. For instance, results of a semantic search may be assigned a weight of 0.8 or higher, while results of a keyword search may be assigned a weight of less than about 0.2. Weights of a semantic search and a keyword search may sum to 1. Retriever 116 may retrieve a top number of data chunks. A top number of data chunks may be determined based on a result of ranking semantic and keyword search results through the application of weightages. In some embodiments, a top number of data chunks may be selected based on a selection criteria. Selection criteria may include, but is not limited to, keywords, key phrases, header paths, and/or other criteria. For instance, a top number of chunks may be determined through consolidation of a hybrid search. A consolidated result of a hybrid search may be ranked according to a selection criteria. In some embodiments, a consolidated result of a hybrid search may be ranked through an AI model. In some embodiments, retriever 116 may retrieve one or more initial data chunks based on a cosine similarity and may re-rank the one or more data chunk using a AI model to select data chunks having a highest relevance. A “cosine similarity” as used in this disclosure refers to a measure of likeness between two or more non-zero vectors. A cosine similarity may be an angle between two vectors, which may be calculated as a dot product of the two vectors divided by the product of their magnitudes. Computing system 150 may be configured to calculate a cosine similarity of two or more data chunks. Data chunks having a higher cosine similarity may have a greater likeness, while data chunks having a lower cosine similarity may have a lower likeness. An AI model, such as a classifier or other AI model, may input data chunks initially ranked via a cosine similarity and may output a reranking of two or more data chunks by relevance. Relevance may be determined by a matching of query 128 to one or more data chunks.

In some embodiments, gen AI model 120 may be configured to preliminarily identify results of retriever 116 and determine a relevance of results of retriever 116 prior to generating answer 140. Relevance may be determined based on a similarity between one or more keywords, semantics, or other textual data of query 128 and data retrieved by retriever 116. In some embodiments, prior conversational histories of gen AI model 120 may be utilized by gen AI model 120 to determine a relevance of data retrieved by retriever 116. In some embodiments, retriever 116 may be a clustering algorithm that may be trained to input keywords and/or semantic strings and output data determined to be relevant to the keywords and/or semantic strings. Training data for a clustering algorithm may be received via user input, external computing devices, and/or previous iterations of processing. Clustering algorithms that may be employed by retriever 116 may include, but are not limited to, K-nearest neighbors, spectral clustering, K-modes clustering, K-means clustering, Gaussian models, and/or any other type of clustering algorithm.

Computing system 150 may obtain data from retriever 116 for input into gen AI model 120. Gen AI model 120 may be any type of artificial intelligence (AI), such as, but not limited to, natural language processing (NLP), generative adversarial network (GAN), a generative pre-trained transformer a variational autoencoder (VAE) a recurrent neural network (RNN), or other types of Al. Gen AI model 120 may be configured to interact with retriever 116. In some embodiments, retriever 116 may be part of gen AI model 120. Gen AI model 120 may be trained to generate answer 124 based on queries 128, documents 104 and/or other training data. In some embodiments, gen AI model 120 may be pretrained. For instance, gen AI model 120 may be trained prior to receiving query 128 and/or data chunks of documents 104. Answer 124 may be a textual, pictorial, graphical, or other form of response that may be generated based on query 128, documents 104 and/or other training data. Gen AI model 120 may generate answer 124 based on one or more processed queries 128 via query processing 132 and/or one or more data chunks generated by chunking process 108. Gen AI model 120 may be configured to utilize one or more generated answers 124 to generate one or more subsequent answers 124. In some embodiments, through a hybrid retrieval approach of retriever 116 as described herein, answer 124 may be accurately generated regardless if query 128 includes narrative sentences or keyword lists.

Referring now to FIG. 1B, another embodiment of a system architecture is presented. System 100B may include secure storage system 164 that may store one or more documents 166. Documents 166 may be loaded into a data chunking process 168. Data chunking process 168 may convert one or more documents 166 into one or more data chunks. Data chunks may be meaningful data chunks, which refers to data chunks having a relevance to a query. One or more data chunks may be stored in vector database 178.

In parallel or sequence, user 172 may provide query 174 to system 100B. Query 174 may be processed via query process 170 to determine conversational context between user 172 and gen AI model 182. Query 174 may be expanded upon to include additional context determined to be relevant to a current conversation between user 172 and gen AI model 182. For instance, query 174 may become context-aware. A “context-aware query” as used in this disclosure refers to a query that has been modified to incorporate context of one or more previous conversational histories between a user and a gen AI model. In some embodiments, a query, modified or unmodified, may be stored in database 178, such as, but not limited to, a vector database.

Retriever 180 may be in communication with gen AI model 182, which may be a gen AI LLM. Retriever 180 may retrieve one or more data chunks deemed relevant based on a received query 174. In some embodiments, data chunks may be classified via header levels. Header levels may be embedded into meta data of one or more data chunks. In some embodiments, one or more data chunks may be ranked and/or reranked by retriever 180. For instance, two or more data chunks may be deemed similar due to a calculated cosine similarity between them. An AI model, which may be part of retriever 180, may rerank two or more data chunks having a cosine similarity based on a relevance to a query. Data chunks and queries may be used as input to gen AI model 182. Gen AI model 182 may generate a partial answer for every data chunk retrieved. In some embodiments, gen AI model 182 may iteratively generate a partial response for every unique header received. In other embodiments, gen AI model 182 may generate a comprehensive response after receiving a threshold amount of data chunks. In some embodiments, a plurality of partial responses may be combined to form a comprehensive response by a gen AI model. In some embodiments, a first gen AI model may form one or more partial responses and a second gen AI model may formulate a comprehensive response based on the partial responses output from the first gen AI model. In other embodiments, gen AI model 182 may form a comprehensive response based on partial responses it may have previously generated. Gen AI model 182 may provide answer 184 to query 174. Answer 184 may be augmented by an example via example augmentation 188. For instance, gen AI model 182 may provide an example illustrating a concept related to query 174 to user 172. Answer 184, which may be modified to include an example, may be formatted to a specific output via formatting process 190. Formatting process 190 may include, but is not limited to, adjusting headers, body paragraphs, lists, and/or other parts of answer 184. Each of the parts of system 100B are described in further detail below.

### Query Processing

Referring now to FIG. 2, a flowchart of process 200 for query processing is presented. Query processing may be performed by a computing system, such as computing system 150 described above with reference to FIG. 1. In some embodiments, query processing may be performed by an Al or machine learning (ML) model. In some embodiments, process 200 may be performed by a natural language processing (NLP) model.

At step 205, a query is received. A query may include any inquiry for information as described herein, without limitation. A query may be received as a full sentence, a list of keywords, an image, a data table, or any other form of input. In some embodiments, a query may be limited to a word count of 500 words or less. In other embodiments, a query may be limited to a word count of greater than about 500 words. A query may be received in the form of a chat box, which may be presented to a user. A query may have various headers, sub-headers, body paragraphs, conclusions, or other structures. In some embodiments, a query may have multiple sub-queries. For instance, a query may include a single question with multiple sub-parts, all relating to the overarching question. In some embodiments, multiple queries may be received simultaneously or in series. Multiple queries may share a context. In other embodiments, multiple queries may be directed to different contexts. Process 200 may be adapted to handle multiple queries with various sub-parts directed towards a same or different context. For instance, a computing system and/or AI/M L model may be configured to identify multiple queries in a single query and corresponding contexts, such as by using one or more steps described below, without limitation.

At step 210, a query may be rectified and/or corrected, for instance, by correcting typographical errors, grammar, or other semantic issues. Query rectification may include formatting dates, times, names, addresses, and/or any other information. In some embodiments, query rectification may include dividing running on sentences into two or more separate sentences, adding oxford commas, removing oxford commas, adding question marks, removing question marks, rearranging an ordering of one or more nouns, adjectives, actions, subjects, and/or other forms of rectification. Rectification of a query may include modifying a query to recite an inquiry in a more grammatically appropriate and precise way than a user may have originally entered a query, which may improve response generation of a gen AI model. In some embodiments, a rectified version of a query may be presented to a user for acceptance, modification, and/or deletion. In other embodiments, rectification and further processing of a query may happen automatically. Rectification of a query may be performed by a language model, in some embodiments, such as any language model described herein. Rectification may be performed by an AI/ML model, such as, but not limited to, a gen AI model or LLM. A gen AI model or LLM may be trained with a plurality of queries corresponding to a plurality of rectified queries, and may, responsive to training, be configured to input a query and output a rectified query. Training data may be received via user input, external computing devices, and/or previous iterations of processing.

At step 215, a query may be expanded. For instance, one or more abbreviations may be identified by a computing system and/or AI/ML. In some embodiments, every abbreviation identified may be expanded. In other embodiments, abbreviations deemed crucial to a query may be expanded, while other abbreviates not deemed crucial to a query may remain in abbreviated form. A crucialness to a query may be determined based on a context of a query. For instance, an abbreviation of “the 9^{th}” to refer to January 9^{th} may not be expanded, while the words “ref. no.” may be expanded to “reference numeral.” In some embodiments, query expansion may include expansion of one or more abbreviations to full form names. Abbreviations that may be expanded include, but are not limited to, person names, company names, item names, shorthand names, reference numbers, and/or other information. For instance, city names, organization names, dates, times, and/or other information may be expanded from shorthand reference to full form. In some embodiments, one or more abbreviations of a query may be expanded based on a comparison with a pre-defined list of abbreviations that should be expanded. A pre-defined list may be initially formed via a user. In some embodiments, a pre-defined list may continuously be updated by a gen AI model based on feedback from one or more responses and/or identification of abbreviations in one or more queries. A context awareness of a query may be determined using one or more of the subsequent steps described below.

At step 220, contextual analysis is performed. Contextual analysis may include determining one or more themes, overall contexts, immediate contexts, relevance to prior conversations, relevance to preceding queries, implicit contexts, and/or any other form of contexts. In some embodiments, step 220 may be performed by an AI model in response to one or more prompts input to the AI model. Prompts may include one or more instructions for an AI model to determine contexts such as, but not limited to, themes, overall contexts, immediate contexts, relevance to prior conversations, relevance to preceding queries, implicit contexts, and/or any other form of context. In some embodiments, contextual analysis may be performed by comparing an instant query to one or more previous queries. A prompt may be given to an AI model instructing the AI model to compare an instant query to one or more previous queries. For instance at step 225, immediate relevance of a query may be determined. An immediate relevance may include comparing a query to a current conversation of a gen AI model. Based on a similarity between a query and a current conversation, an immediate relevance to the current conversation may be determined. An immediate relevance may be determined as a percentage or other numerical value, such as, but not limited to, 10% relevant, 20% relevant, 30% relevant, 40% relevant, 50% relevant, 60% relevant, 70% relevant, 80% relevant, 90% relevant, 100% relevant, and/or any ranges in between. A similarity may be determined based on a comparison to one or more keywords, phrases, subjects, nouns, adjectives, and/or other textual data. An immediate relevance may be determined by a threshold amount of keywords, semantic structure, or other

At step 230, a broader context of a query may be determined. A broader context may include relevance to an overall topic or theme. A broader context may be determined based on one or more identified topics and/or themes of a conversation. Determining a broader context may include comparing one or more keywords, synonyms, phrases, nouns, subjects, adjectives, or other textual data to one or more identified key keywords, phrases, nouns, subjects, adjectives or other textual data. A broader context may be determined by comparing a query to one or more identified relevant conversations. For instance, two or more conversations may be determined relevant to a query and may share a context but may not share a specific inquiry. A broader context may be determined to relate to a current conversation but at a higher level, which may help avoid identifying a query as being related to a new topic or theme from a current conversation. A higher level may refer to an overarching theme or objective of two or more queries. For instance, broader contexts may include, but are not limited to, account creations, shipping logistics, scientific principles, historical events, customer data, company data, or any other context, without limitation.

At step 235, thematic connections and references may be identified. Thematic connections may include relations between two or more topics, categories, subjects, or other grouping of relations. A query may be determined to relate to a particular theme that may be present between two or more categories of discussion over the course of one or more conversations with a gen AI model. References of a query may also be determined and/or identified. References may include textual data that refer to other textual data. For instance, a query may have a reference to a prior conversation, theme, topic, or other categories of information. Thematic connections and references may be identified to determine recurring topics and/or subjects, in some embodiments. For instance, themes may include, but are not limited to, scientific principles, periods of history, shipping logistics, company revenue, customer data, account creation, system troubleshooting, or any other theme, without limitation.

At step 240, implicit references of a query may be determined. Implicit references may include indirection mentions or implied topics that may be relevant to a query. For instance, a query may indirectly infer or suggest a topic or subject. In some embodiments, a query may imply one or more data points, questions, or relations to other topics, questions, or data points. For instance, a query may imply a previous fact was stated by a gen AI model, may imply a course of action should be taken, may imply economic and/or environmental conditions, and/or other implications.

At step 245, a query relevance is determined. A relevance of a query may include assessing any contextual awareness described above. For instance at step 250, a relatedness of a query may be assessed. A relatedness may be determined based on, but not limited to, prior conversation history, immediate relevance, broader contexts, thematic connections and/or references, and/or implicit references. In some embodiments, a weight may be assigned to one or more variables in determining a relatedness of a query. A weight may be a numerical value between 0 and 1. A weight may reflect a relative importance of a variable with respect to one or more other variables. For instance and without limitation, immediate relevance may have a weight of 0.4, broader context may have a weight of about 0.2, thematic corrections and references may have a weight of about 0.3, and implicit references may have a weight of about 0.1. Any weight may be assigned to any variable, without limitation.

At step 255, a query may be adapted based on a relatedness assessment. For instance at step 260 a query may be determined to be related to a conversation. A query determined to be related to a conversation may be expanded upon with any of the contextual data determined above. For instance, a query may be expanded to include additional context relating to immediate relevance, broader contexts, thematic connections and references, and/or implicit references. Expansion of a query to include additional context may include reformatting and/or modifying the query to refer to one or more identified contexts. For instance, a reference to a previous conversation, a specific theme, or any other forms of context may be added to a query. As a non-limiting example, an original query may recite “What do I do after that?” to which the query may be modified to recite “Based on our conversation yesterday regarding setting up account credentials, you had told me to come up with a username. What do I do after creating a username?”. An expansion of a query based on determined contextual analysis may ensure a response is generated from an LLM that is more accurate, comprehensive, and relevant to a conversation.

At step 265, a query may be determined to be unrelated to a conversation. If a query is determined to be unrelated, it may be treated as an entirely new query, without any context or links back to previous conversations, themes, topics, subjects, or other data. Determination of an unrelated query may ensure that responses to a new query are generated independently from prior conversations and/or queries, which may reduce incorrect contextual associations.

### Prompt Templates and Response Generation

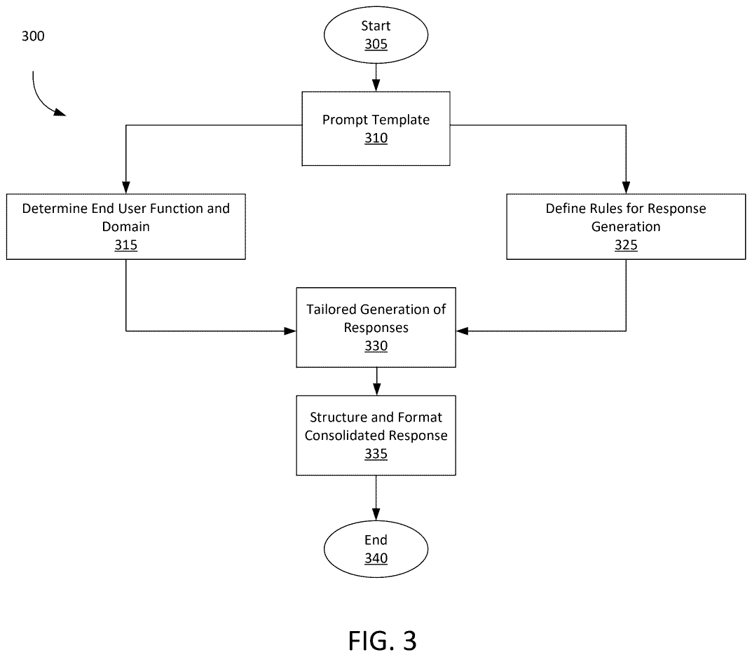

Referring now to FIG. 3, a process 300 for generating a response using a prompt template is presented. Process 300 may be performed by a computing system, such as computing system 150 described above with reference to FIG. 1A. In some embodiments, query processing may be performed by an AI or ML model. In some embodiments, process 200 may be performed by an NLP model. In some embodiments, process 300 may be used to implement one or more prompt templates to generate complete and accurate responses to a query.

At step 305, a prompt may be provided. A prompt may be provided by a user or computing device which may initiate prompt template 300. In some embodiments, process 300 may be structured for semantic response generation. Semantic response generation may include textual or other linguistic data formatted as a response to a prompt, without limitation.

At step 310, an initial prompt template is provided. An initial prompt template may be received via user input and/or a computing device. An initial prompt template may include roles, contexts, or other parts of a prompt template described herein. An initial prompt template may be selected from a variety of prompt templates based on a context and/or intent of a prompt received at step 305. Prompt templates may include textual and/or pictorial data that may be relevant in generating a response to a query. For instance, a prompt template may define a role for a gen AI model, may provide context relating to one or more prior conversational histories with a gen AI model, and/or may provide a format for a query having multiple parts. A prompt template may include a determination of end user function and domain, may match relevant information for a gen AI model's in-context learning, and/or may define one or more rules for response generation, described in more detail below.

At step 315, an end user function and/or domain are determined. An end user function and/or domain may be determined in response to an instruction given through a prompt template. An instruction may include, but is not limited to, “what is the user's role?” or other similar questions. In some embodiments, an end user function and/or domain may be determined by a gen AI model automatically. End user functions and/or domains may be provided via user input and/or computing devices. End user functions may include use cases for a gen AI model that may be applicable to an end user's objective. For instance, end user functions may include, but are not limited to, data reports, data analytics, coding projects, or any other end user function. In some embodiments, end user functions may include determined use cases of a response generated by process 300. Use cases may include, but are not limited to, data analytics, entity organization, coding projects, or any other use case. At step 320, a domain of an end user may be determined. Domains may include roles and/or titles given to a gen Al model. For instance, domains may include, but are not limited to, head engineer, backend developer, front end developer, or other domains. End user functions and/or domains may be provided by the prompt template of step 310. In other embodiments, end user functions and/or domains may be identified by a gen AI model based on textual data of a prompt received at step 305.

At step 325, rules for response generation are defined. Rules may include restricting or encouraging certain actions of a gen AI model. For instance, rules may prohibit a gen AI model from using data external from a determined context, user function, and/or domain. Rules may include instructions to provide one or more fallback answers. A “fallback” answer as used in this disclosure is a response generated by a gen AI model under the circumstances of not having enough information to generate a proper response. Fallback answers may include notifying a user that context is missing, data is insufficient, or other fallback answers. As a non-limiting example, rules may include a fallback answer of “If the CONTEXT does not contain enough information to answer a question, respond EXACTLY with: “I don't have enough information to answer that. I'm still learning, so could you please rephrase or provide more details about your question?”.

Still referring to step 325, rules may include restricting or prohibiting actions of a gen AI model, such as making inferences beyond a scope of an identified context, prohibiting the generation of code, prohibiting accessing external databases, or prohibiting other actions. In some embodiments, rules may include encouraging one or more actions of a gen AI model. For instance, rules may include instructing a gen AI model to follow up with additional questions, including a web link determined to be relevant to a context of a prompt, stating determinations about context with respect to formulating a response, or other actions. As a non-limiting example, a rule defined for a gen AI model may include “If a question asks about multiple items and you can only answer part of it, provide the information you have and state that the context doesn't contain information for the rest.”

At step 330, generation of responses may be tailored. For instance an instruction may be provided to a gen AI model to rephrase or re-direct semantic data towards an end user function, domain, or other data. In some embodiments, responses may be tailored based on an identified context, conversational history, previous prompts, and/or other data. A tailoring of responses may include omitting words and/or phrases deemed by a gen AI model to not be relevant to an end user. In some embodiments, a response may be tailored based on steps 315-325, as described above.

At step 335, a response is structured and formatted. A response may be consolidated. An instruction may be provided to a gen AI model to structure and/or format a response in a particular way. Consolidation may include rephrasing and/or rewording a response to be more concise, fit within a word-count or page limit, or other types of consolidation. In some embodiments, structuring and formatting a response may include providing semantic data generated by any of the previous steps in as a bullet list, paragraph form, data report, journal entry, or any other type of formatting of semantic data. At step 340, process 300 may end. In some embodiments a user or computing device may provide an additional prompt and process 300 may start over at step 305.

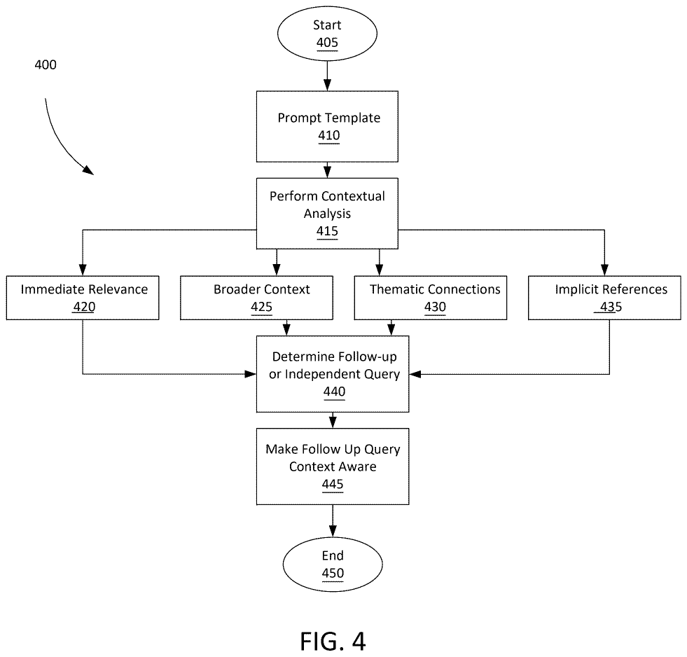

Referring now to FIG. 4, a process 400 for creating context aware queries is presented. Process 400 may be performed by a computing system, such as computing system 150 described above with reference to FIG. 1A. In some embodiments, query processing may be performed by an AI or ML model. In some embodiments, process 200 may be performed by an NLP model. At start 405, a user or computing device may provide a prompt and/or query. Prompt template 400 may be used by a gen AI model to condense conversational context in formulating responses to queries, in some embodiments.

At step 410, an initial prompt template is provided. An initial prompt template may include one or more roles, contexts, intents, objectives and/or goals, or other data of a prompt template described herein. An initial prompt template may be selected from a plurality of prompt templates based on a context and/or objective of a prompt received by a user or computing device. A prompt template may include one or more instructions for a gen AI model to formulate a response to a query with. Prompt template 410 may provide a gen AI model with one or more roles, response restrictions, desired formatting of responses, or any other instruction that may be given to a gen AI model.

At step 415, contextual analysis may be performed. For instance, a gen AI model may determine a context and/or intent of a prompt. A contextual analysis may be determined based on data of a prompt template, such as the prompt template at step 410. Contextual analysis may include determining objectives, intents, end users functions, domains, roles, tasks, and/or any other data of a prompt and/or query. An instruction may be provided to a gen AI model to perform a contextual analysis.

At step 420, immediate relevance may be determined. For instance, a prompt template may include instructions for a gen AI model to determine an immediate relevance of a query. Immediate relevance may include data determined to be most similar to a present context or intent of a query. For instance, immediate relevance may be directly related to a context or intent of a query. An instruction may be provided to a gen AI model to determine a relevancy of a response to a context or intent of a query.

At step 425, a broader context may be determined. For instance, a prompt template may include instructions for a gen AI model to identify a broader context of a query. An instruction may be provided to a gen AI model to include context that may be broader than an immediate relevance to a current query. A broader context may extend beyond a scope of immediate relevance of a query, such as an immediate relevance determined above in step 420. A broader context may include relations to previous parts of a chat history, previous topics, previous queries, and/or other contexts. A broader context may be identified based on a plurality of previous queries and/or responses, in some embodiments. A broader context may encompass two or more related queries.

At step 430, thematic connections may be determined. For instance, an instruction of a prompt template may be given to a gen AI model to determine one or more thematic connections of a query. Thematic connections may include relevant areas of discussion, query/response topics, or other data. For instance and without limitation, thematic connections may include discussion of weather, coding projects, organizational operations, or other thematic connections. An instruction may be provided to a gen AI model to incorporate one or more thematic connections of previous queries and/or responses into a response.

At step 435, implicit references may be determined. Implicit references may include continuations of topics, ideas, areas of discussion, or other data of previous conversational history with a user. An instruction may be provided to a gen AI model to include implicit references in formulation of a response. Steps 420, 425, and/or 430 may be performed as part of the contextual analysis performed in step 415. In some embodiments, a weightage may be applied to outcomes of any of the above steps. Weightage may be a numerical value that may represent an overall importance of an attribute. Weightage may be between about 0 to about 1, 0% to about 100%, or other numerical values, in some embodiments. For instance, and without limitation, immediate relevance may have a weight of about 45%, thematic connections and/or references may have a weight of about 20%, implicit references may have a weight of about 25%, and broader contexts may have a weight of about 10%. Any weights of any of the previously described variables may be adjusted or tune to any number, without limitation. In some embodiments, immediate relevance may have a highest weightage. For instance, immediate relevance may have a weightage of about 40% or greater. Immediate relevance may have a higher weightage than one or more other variables due to a direct relationship to a query. Contextual analysis may help ensure responses generated by a gen AI model follow a topic of discussions and remain relevant despite changing contexts of one or more prompts. In some embodiments, an aggregate score may be calculated based on, but not limited to, immediate relevance, thematic connections and/or references, implicit references, and/or broader contexts. An aggregate score may be any number between about 0% to about 100%. An aggregate score may indicate a likelihood that a follow-up query is related to one or more previous queries. In some embodiments, a score above about 60% or greater may indicate that a follow-up query is related to one or more prior queries. In some embodiments, an aggregate score may be calculated for two or more prior queries of a set of queries. A sum of aggregate scores of two or more prior queries in a set of quires may be calculated and used to determine a relevance of a follow-up query to one or more prior queries.

In some embodiments, a sentiment and/or tone analysis may be performed. A sentiment and/or tone analysis may include analyzing one or more parts of a query to determine tones such as, but not limited to, frustration, curiosity, or other tones. In some embodiments, a machine learning model may be utilized to determine a sentiment and/or tone of a query. A machine learning model may include an LLM, in some embodiments. Machine learning models may be trained with training data correlating queries to sentiments and/or tones. Training data may be received via user input, external computing devices, and/or previous iterations of processing. A machine learning model may identify one or more structures of a query, such as, but not limited to, verbs, nouns, subjects, adjectives, conciseness, and/or other parts of a query to determine a sentiment and/or tone of a query. A sentiment and/or tone may be analyzed from one or more previous interactions with an LLM, such as one or more queries and/or responses generated. Utilization of a sentiment and/or tone analyzed from one or more queries may enable generation of empathetic responses that take into account sentiments and/or tones of a query.

In some embodiments, a machine learning model may perform anaphora resolution. A naphora resolution may include resolving pronouns and/or ambiguous references from past queries. For instance, a query may recite “it” or “they”, which may be ambiguous in a current tense. A machine learning model may analyze and resolve ambiguous terms through determining one or more term meanings based on one or more previous queries and/or responses generated, which may add context to a current query.

At step 440, a follow-up or independent query may be determined. For instance, if a user or computing device provides a second prompt and/or query after an initial prompt and/or query at step 405, a gen AI model may determine if the second prompt and/or query is separate from an initial prompt and/or query or a continuation of an initial prompt and/or query. If a prompt is determined to be a follow-up prompt, a gen AI model may incorporate context and/or previous data of a previous prompt into a response formulated based on the follow-up prompt. If a prompt is determined to be an independent prompt and/or query, a gen AI model may omit data and/or context of a previous prompt and/or query. An instruction may be provided to a gen AI model to determine if a subsequent prompt is a follow-up or independent query.

At step 445, a follow up query may be made context aware. A query may be adapted to fit a determined context. For instance, a query may be expanded upon to include additional contexts relating to immediate relevance, broader contexts, thematic connections, implicit references, or any other type of context. If a query is determined to be a follow up query based on contextual analysis performed at step 415, the query may be expanded upon to include additional context identified. Adaption and/or expansion of a query may include adding one or more characters, symbols, sentences, and/or phrases identified as being relevant to a the query. A query may be adapted and/or expanded on using an LLM or other M L model. An LLM or other ML model may be trained with training data of a plurality of query and response pairs and/or conversational histories. Training data may be received via user input, external computing devices, and/or previous iterations of processing. An LLM or other M L model may be configured to receive a query and at least one previous query and response pairing, and may output an adapted query that may incorporate any identified context from previous query and response pairings and/or conversational histories. Contexts and/or data relevant from an initial or related query may be incorporated into a response by a gen AI model. An instruction may be provided to a gen AI model to incorporate contexts, thematic connections, implicit references, or any other data in a response. Process 400 may end at step 450.

### Data Chunking

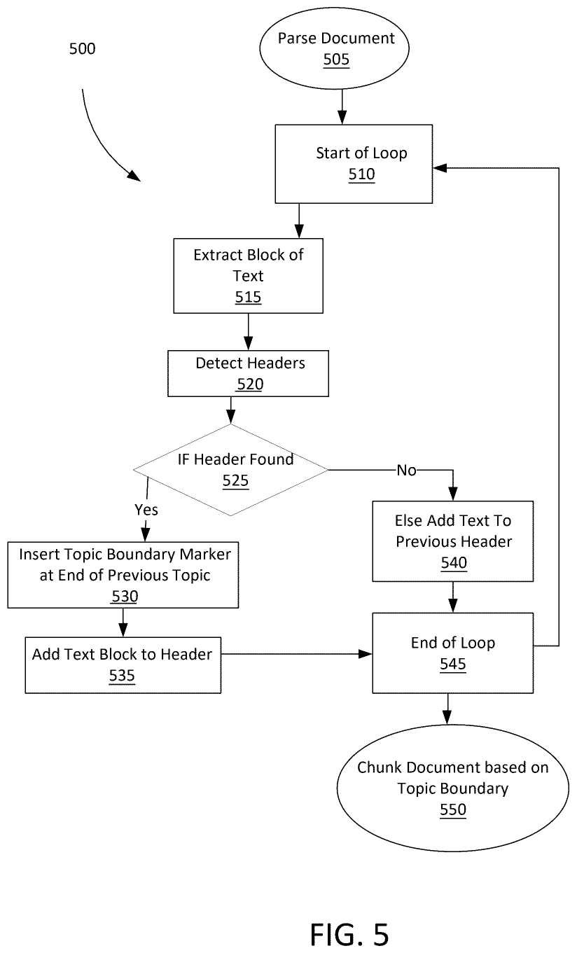

Referring now to FIG. 5, a flowchart of a chunking process 500 is presented. Chunking process 500 may be performed by a computing system, such as computing system 150 described above with reference to FIG. 1A. In some embodiments, query processing may be performed by an AI or ML model. In some embodiments, process 200 may be performed by an NLP model. At step 505, one or more documents may be parsed. Documents may be parsed based on, but not limited to, headers, body paragraphs, footers, titles, abstracts, and/or any other type of sub-part of a document.

At step 510, a loop of process 500 is initiated. For instance, process 500 may loop indefinitely. In other embodiments, process 500 may loop until a condition is met. A condition may include a stop trigger, a quantity of parsed documents, and/or other condition.

At step 510, blocks of text are extracted. Blocks of text may be extracted from one or more parsed documents. Any form of text may be extracted as blocks of text, without limitation.

At step 515, headers are detected. Headers may be detected based on formatting of parsed documents, keywords, key phrases, and/or other data. Headers may include starting points and/or titles of a document that may relate to a body of a document.

At step 520, a determination of an identified header is made. In some embodiments, a header may be identified and process 500 may continue to step 525. At step 505, a topic boundary marker is inserted into the parsed document. In some embodiments, a topic boundary marker may be inserted into the identified header. A topic boundary marker may mark an end of a previous topic and a start of a new topic. A topic boundary marker may include, but is not limited to, highlighted text, bold and/or underlined text, key phrases, keywords, characters, symbols, or other markers.

In some embodiments, a header may not be identified. If a header is not identified, process 500 may proceed to step 535. At step 535, text may be added to a previous header if a header is not determined to be found at step 520.

At step 540, if a header is not found at step 525, text may be added to a previous header.

At step 545, a loop of process 500 may terminate. At step 550, one or more documents may be chunked based on inserted topic boundaries. Process 500 may help ensure topic content in a topic related chunk of one or more documents is selected in a gen AI model's response formulation. By chunking documents through process 500, a probability that relevant chunks of documents being selected by a gen AI model in formulation of a response may be increased.

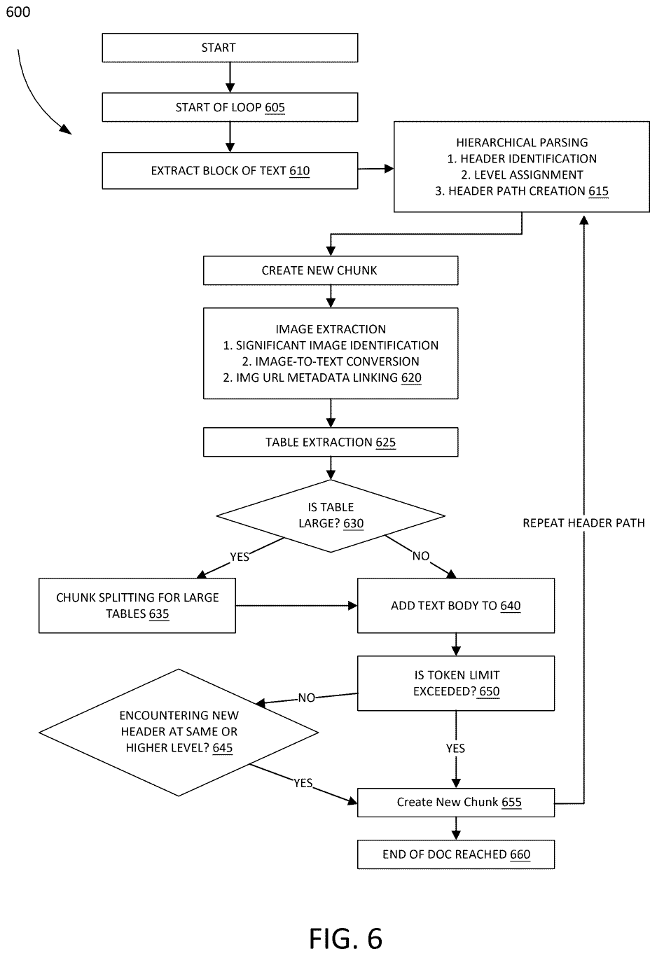

Referring now to FIG. 6, another flowchart of a process of data chunking 600 is shown. Process 600 may be performed by a computing system, such as computing system 150 described above with reference to FIG. 1A. In some embodiments, query processing may be performed by an AI or ML model. In some embodiments, process 200 may be performed by an NLP model. At step 605, process 600 may start. Process 600 may start in response to receiving one or more new documents. In some embodiments, process 600 may start in response to user input or other conditions.

At step 610, blocks of text may be extracted from one or more documents. For instance, a text recognition process may be performed to identify one or more textual characters within one or more documents. In some embodiments, documents that have editable text, such as word documents, power points, PDFs, or other documents may allow for a direct extraction of text. Identification of text may be performed using optical character recognition (OCR), natural language processing (NLP), deep learning, or other processes. In some embodiments, extraction of text may include a preprocessing of one or more documents, which may ensure clean and raw input data may be extracted. Preprocessing may include removing metadata, special characters, HTML tags, or other data.

At step 615, a hierarchical parsing may be performed on extracted text of one or more documents, Hierarchical parsing may include identifying header information, sub-header information, numbering indentation, font size, body paragraphs, and/or other data. One or more levels may be assigned to various parts of a document. For instance a level of “0” may be assigned to a document title, while subsequent headers may incrementally be assigned ascending level numbers. One or more header paths may be created. A header path may link a header to an assigned level, which may be hierarchical. In some embodiments, a header path may be a collection of two or more headers linked together in a hierarchical order. For instance, and without limitation, a header path may include a level 0 header, which may be title of a document, a level 1 header, which may be a first header encountered after the title of the document, and then one or more subsequent headers encountered after the first header, which may have ascending level headers reflecting more granular information within the document. In some embodiments, meta data of a data chunk may be enriched at step 615. For instance, meta data embedding a hierarchical level system may be implemented into a data chunk. In some embodiments, one or more header paths may be embedded into meta data of one or more data chunks.

At step 620, image extraction may be performed. For instance, regions of interest where text may be likely to exist may be identified, such as through boundary analysis, edge detection, contour analysis, Stroke Width Transform (SWT), and/or Maximally Stable Extremal Regions (MSER). In some embodiments, OCR may be used. LLM vision models may be used to convert images into text, in some embodiments. Image extraction may include a threshold region of a document. For instance, a top and bottom 10%, greater than 10%, or less than 10% may be ignored to avoid extracting headers and/or footers of a document. In some embodiments, image extraction may include selecting areas within a document that occupy more than at least 10% of the document area. Non-essential images like icons may be ignored. Image documents may be stored in a database and links to chunks of the image documents may be embedded into the chunks as meta data.

At step 625, one or more tables may be extracted from identified text. Tables may include rows and/or columns of data, such as numerical and/or textual data. In some embodiments, a plurality of tables may be identified.

At step 630, a determination if a table is large is made. A large table may include more than 20 rows and/or columns. In some embodiments, a large table may include less than or greater than 20 rows and/or columns. A threshold for determining if a table may be classified as large may be set by a computing system and/or user input. If a table is determined to be large, process 600 proceeds to step 635. At step 635, chunk splitting for large tables is performed. A large table may be split into one or more smaller chunks, with each smaller chunk having a header path that may be used to ensure recombination during retrieval. Large table data may be split and added to a text body of a chunk at step 640. If a table is determined to not be large, text of the table may be added to a body of a chunk at step 640.

At step 645, a determination of if a token limit is exceeded may be made. For instance, one or more chunks may be assigned a token. A token may represent a word in a data chunk. In some embodiments, there may be a limit to an amount of tokens used, such as about 512. If a token limit is exceeded, a new chunk with a same header path may be created. If a token limit is not exceeded, a determination at step 650 of if a new header at a same hierarchal level or higher is encountered. If it is determined a new header at a same or higher hierarchical level is encountered, a new data chunk may be formed. New chunks may be formed with a same header path, which may enable a handling of data spillover when chunking one or more documents. At step 655, an end of a document is determined to be reached.

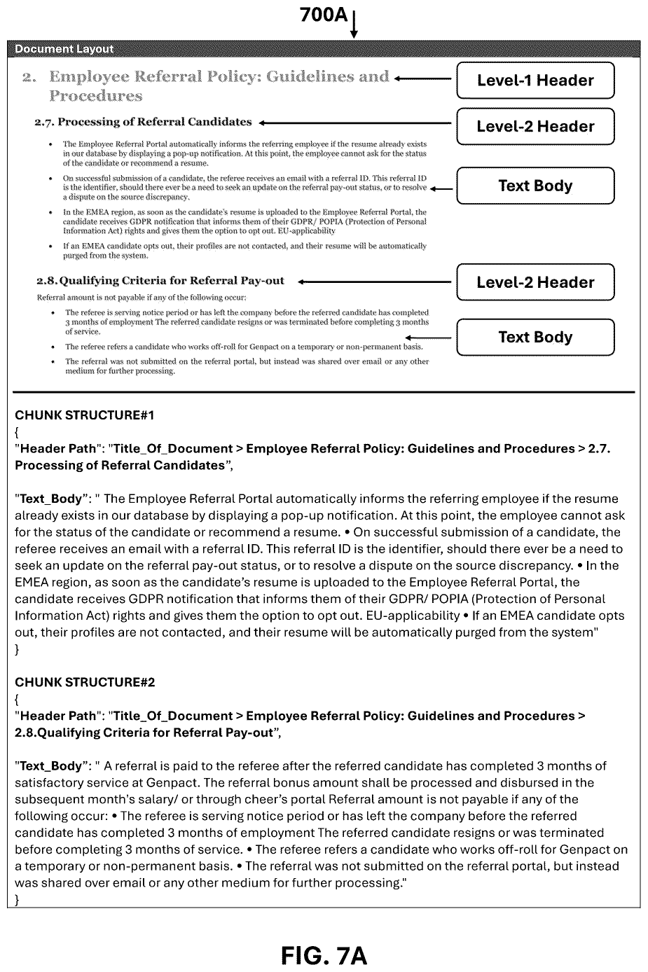

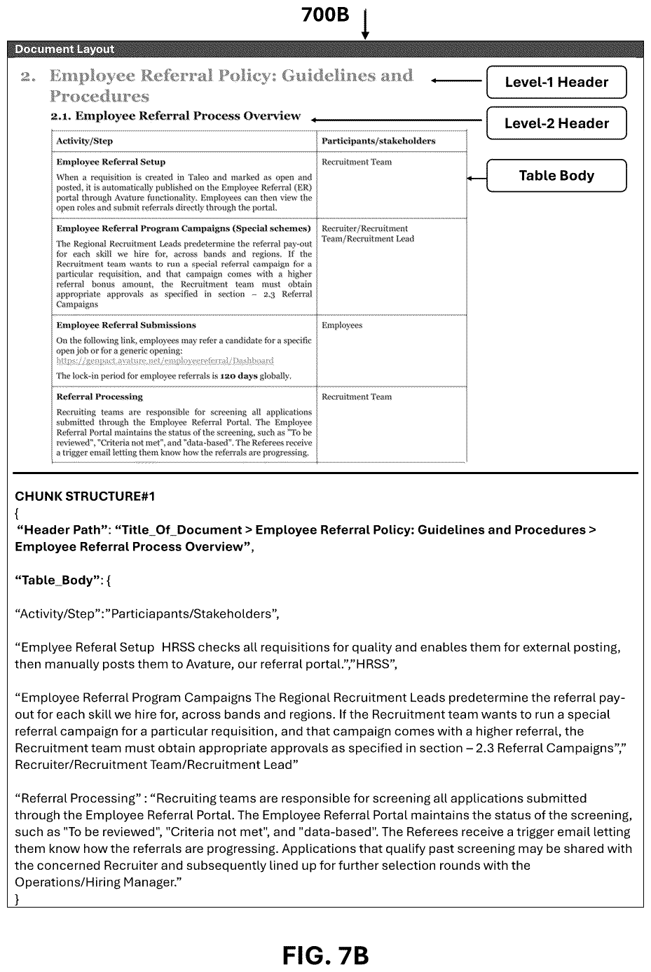

Referring now to FIGS. 7A-B , an example illustration of a chunked document 700A, B is presented. Referring to FIG. 7A, a document 700A with a textual body is presented. Document 700A may include text, icons, numerical values, various fonts, line spacing, paragraph formatting, indentation, headers, footers, and/or any other data in any document described herein. Document 700A may be chunked into one or more portions of data. For instance, the title “2. Employee Referral Policy: Guidelines and Procedures” may be chunked and assigned a level 0 header. The sub-title “2.2 The referrals and leads are defined as follows” may be chunked and assigned a level 1 header. The remainder of document 700A may be chunked and assigned a title of text body.

Referring to FIG. 7B, a document 700B with a table is presented. Document 700B may include text, table, icons, numerical values, various fonts, line spacing, paragraph formatting, indentation, headers, footers, and/or any other data in any document described herein. Document 700B may be chunked into one or more portions. For instance, the title “2. Employee Referral Policy: Guidelines and Procedures” may be chunked as a level 0 header. The sub title “2.1 Employee Referral Process Overview” may be chunked and assigned a level 1 header. The table may be chunked and labeled as a table body. Header paths may be formed in hierarchical order and may be separated by the character “>”. Table contents may be represented as JSON data, in some embodiments.

### Retrieval Processes

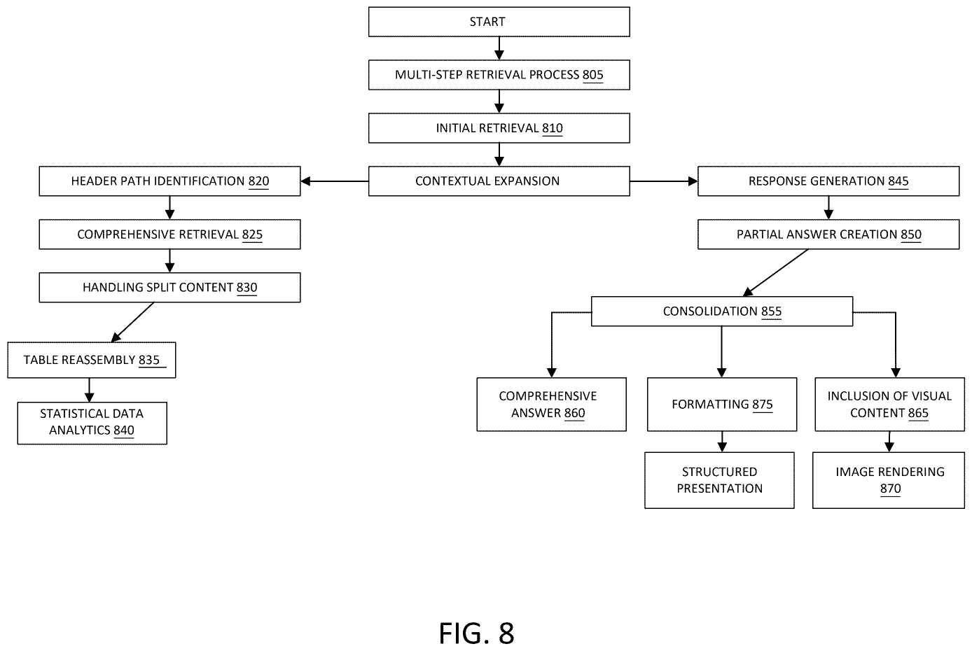

Referring now to FIG. 8, a retrieval process 800 is presented. Retrieval process 800 may be performed by a computing system, such as computing system 150 described above with reference to FIG. 1A. In some embodiments, query processing may be performed by an AI or ML model. In some embodiments, process 200 may be performed by an NLP model. Retrieval process 800 may be used to retrieve one or more data chunks and/or documents in a database. For instance, retrieval process 800 may be used in conjunction with an LLM in formulating a response to a query.

At step 805, a multi-step retrieval process is performed. At step 810, an initial retrieval of one or more data chunks occurs. At step 815, contextual expansion of one or more data chunks is performed. For instance, at step 820, a header path of one or more data chunks is identified. Unique header paths are extracted from a top-ranked number of data chunks. A ranking of data chunks may occur relative to a relevance of a user's query.

At step 825, a comprehensive retrieval is performed. All data chunks sharing one or more header paths may be retrieved, which may ensure full coverage of relevant sections of one or more documents.

At step 830, a handling of split content is performed. Content may be split across multiple data chunks, in some embodiments. Split content may be handled via table reassembly at step 835, and/or statistical data analytics at step 840. For instance, a table split amongst multiple data chunks may be reassembled to reconstruct a table in its entirety. Statistical data analysis may be performed on reassembled tabular data. Statistical data analysis may include grouping and/or aggregating data, identifying anomalies and/or outliers, and/or other forms of statistical data analysis.

At step 845, response generation is performed. For instance, at step 850, partial answer creation is performed based on all the consolidated chunks. For each header path, process 800 may generated partial responses using associated chunks. At step 855, consolidation is performed. For instance, one or more partial responses may be combined into a complete and coherent answer. At step 860, a comprehensive answer is generated using one or more partial responses through the consolidation of step 855.

At step 865, inclusion of visual content is performed. For instance, relevant images may be sourced from one or more stored URLs and may be displayed within a response interface. At step 870, image rendering is performed. For instance, an image may be rendered within a response interface based on data of one or more chunks relating to a user's query.

At step 875, formatting is performed to provide a structured presentation. For instance, a final response of an LLM may be formatted with headings, bullet points, numbered lists, and/or other formatting, which may increase a clarity of a response of an LLM.

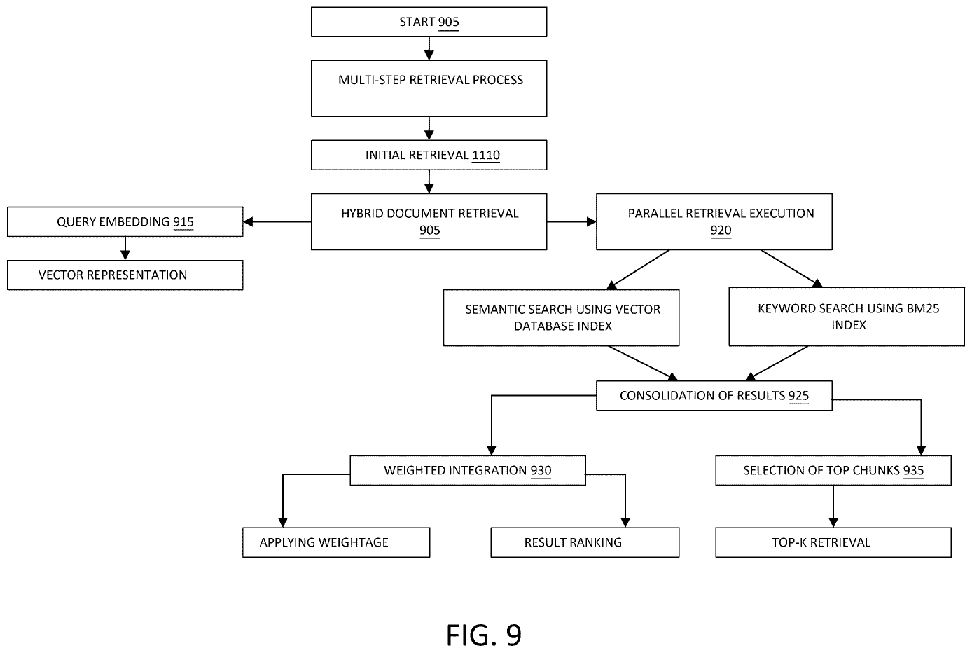

Referring now to FIG. 9, a hybrid retrieval process 900 is shown. Process 900 may be performed by a computing system, such as computing system 150 described above with reference to FIG. 1A. In some embodiments, query processing may be performed by an AI or ML model. In some embodiments, process 200 may be performed by an NLP model. Process 910 may initiated at start 905. At step 910, an initial retrieval of one or more data chunks may occur. At step 910, a hybrid document retrieval may occur. A hybrid document retrieval may include the following steps.

At step 915, query embedding occurs to generate vector representations of a user's query. A user's query may be embedded into a vector using one or more AI embedding models. A user's query may be embedded into a vector to capture semantic meaning of the user's query.

At step 920, parallel retrieval execution occurs using semantic search using vector database index and a keyword search which may use the BM 25 index. For instance, a vector search may be performed by comparing a query vector against vectors of one or more data chunks stored in a vector database index. A vector database index may be, but is not limited to, a Facebook AI Similarity Search (FAISS) vector database index. In parallel, a keyword search using BM 25 index may be performed. A BM 25 ranking function may retrieve one or more data chunks comprising specific keywords from a user's query.

At step 925, a consolidation of results occurs. Results from both a semantic search and a BM 25 keyword matching search may be aggregated or otherwise consolidated.

At step 930, weighted integration occurs of the consolidated results of step 925. One or more weights may be applied to results of a semantic search and/or results of a BM 25 search. In some embodiments, a semantic search may be given a higher weight than a BM 25 search. In other embodiments, a BM 25 search may be given a higher weight than a semantic search. Weights may range anywhere from 0 to 1, with higher numbers representing a more overall important attributed to the results. As a non-limiting example, a semantic search may be weighted as 0.8 while a BM 25 search may be weighted as 0.2.

At step 935, selection of top chunks occurs from the consolidation and weight integration of the previous steps. A top K number of chunks may be retrieved. K may be any number, without limitation.

### Dynamic Example Generation

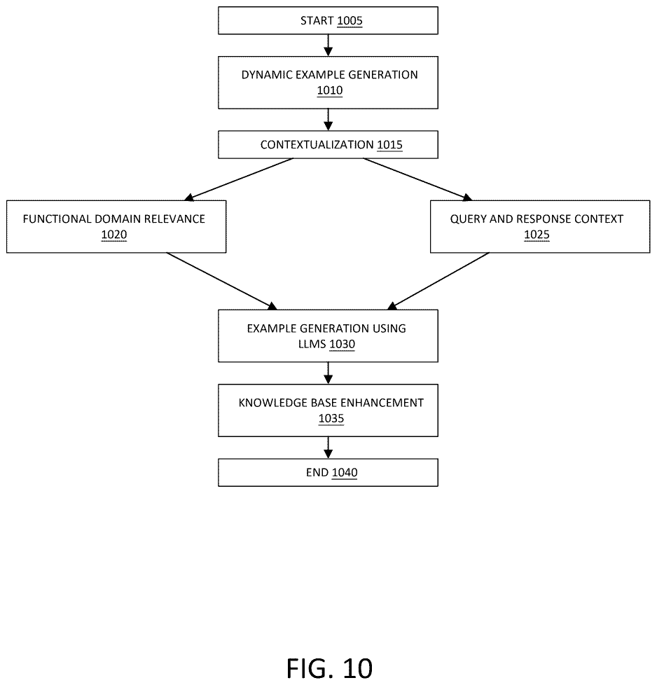

Referring to FIG. 10, a flowchart of dynamic example generation 1000 is presented. Dynamic example generation 1000 may be performed by a computing system, such as computing system 150 described above with reference to FIG. 1A. In some embodiments, query processing may be performed by an AI or ML model. In some embodiments, process 200 may be performed by an NLP model. At start 1005, generation 1000 starts. At 1010, dynamic example generation occurs. Dynamic example generation may include the subsequent steps. Dynamic example generation may include contextualization at step 1015. Contextualization may include determining functional domain relevance at step 1020 and/or query and response contexts at step 1025. Functional relevance may include a user's domain, such as a title of a job or other categorization. Functional relevance may be determined based on user data, data of a query, and/or other data. Query and response context may include determining contexts of one or more previous queries and/or responses.

At step 1030, an example generation using LLMs is performed. An example generation may include simulating various inputs and/or outputs provided by a user's query. In some embodiments, an example generation may include generating a one or more sample responses to a query for a gen AI model to formulate a real response on, which may help the gen AI model to formulate more complete and accurate response compared to formulating a response without an example to start from. Examples may include any form of output by a gen AI model and/or LLM described herein, without limitation. In some embodiments, an example generation may illustrate a topic, theme, subject, or other information. An example may include, but is not limited to, model response covering topics, concepts, metrics, definitions, and/or other examples. In some embodiments, an example may be generated for a user's understanding of a response generated by a gen AI model. For instance, an example illustrating concepts, topics, processes, or other information may be generated. Examples may be textual, pictorial, or a combination thereof. An example may be provided in conjunction with a response generated by a gen AI model, which may assist in user understanding an engagement with information provided by a gen AI model.

At step 1035, knowledge base enhancement occurs. For instance, one or more examples may be added generated in step 1040 may be added to a database. A gen AI model may retrieve one or more examples stored in a database during response generation. In some embodiments, examples generated at step 1030 may be categorized to specific users, formats, topics, prompts, or other information. A database may store examples categorically. A gen AI model may determine an overall context and/or category of a present query and may retrieve an example from a database having a same or similar overall context and/or category. A gen AI model may formulate a response to a present query based in part on an example retrieved from a database. A knowledge base may include any database described throughout this disclosure, without limitation.

In some embodiments, process, systems, and methods described herein may utilize an adaptive response generation template. An adaptive response generation template may be a template that configures a gen AI model to adapt to a query provided by a user. For instance, a query may be received by a user and may be determined to be related to prior conversational history. If a query is determined not to be related to prior conversational history, the query may be processed as a standalone query. If a query is determined to be related to prior conversational history, conversational context may be added to the query via query expansion. A response may be generated based on an expanded or unexpanded query. If a response is not generated, an instruction in an adaptive response generation template may instruct a gen AI model to prompt a user to further elaborate on their query. If a response is generated, a determination if a pairing of a query and the response needing an example is made. A tailored example may be generated based on a determination that a pairing of a query and response requires an example. Examples may include one or more query and response pairings that may aid in a formulation of a response by a gen AI model. Example query and response pairings may be stored in a database and may be retrieved by a gen AI model based on a determination if a query and response pairing of a current conversation requires an example. A determination if a query and response pairing requires an example may be determined by a gen AI model. A response generated by a gen AI model may be formatted. A formatting of a response generated by a gen AI model may include a hierarchical structuring of a response, bulleting, order and/or unorder lists, highlighting of key terms and/or phrases, or any other form of formatting. A user may provide a follow up query which may be processed as described above.

In some embodiments, process, systems, and methods described herein may utilize a user feedback process, which may improve relevancy of responses generated by a gen AI model. For instance, a user may provide feedback and/or suggestions regarding a relevancy and/or accuracy of a response generated by a gen AI model. A gen AI model may capture user feedback and/or suggestions as well as a user query and generated data chunks retrieved in response to a user query. A gen AI model may evaluate relevancy and/or relatedness of a response based on a query and/or data chunks retrieved in response to the query. In some embodiments, one or more data chunks may be revised by a gen AI model to incorporate additional data. In some embodiments, a gen AI model may retrieved one or more related documents and may fine-tun an LLM on one or more queries and related documents. An output of an LLM may add to a query expansion of a query to improve relevancy. For instance, an output of an LLM may add data determined to be relevant to a query in a query expansion process.

### Methods

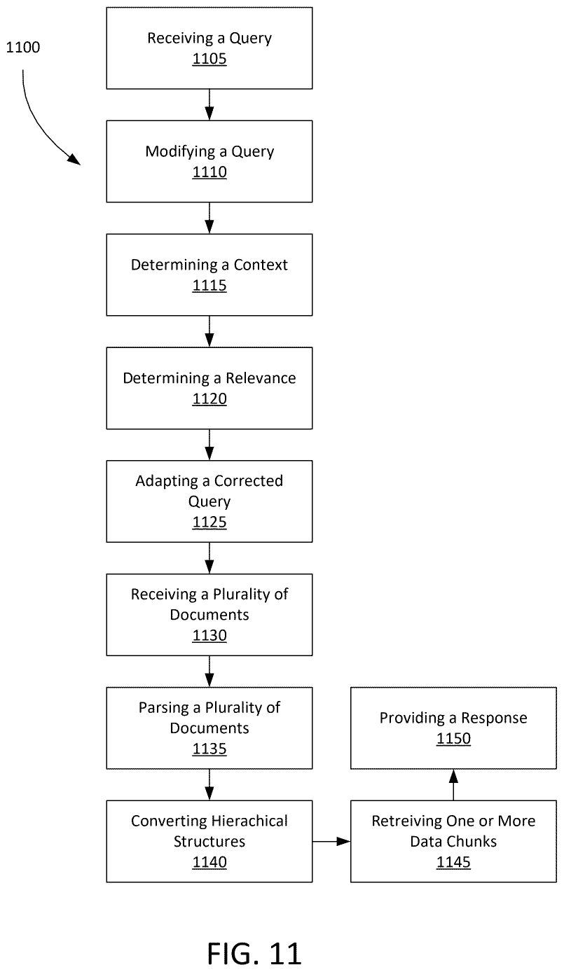

Referring now to FIG. 11, a method 1100 of generating an accurate and complete response using gen AI is shown. At step 1105, method 1100 includes receiving a query. A query may be received via a user interface. In some embodiments, a query may include textual and/or visual data. This step may be implemented as described above with reference to FIGS. 1-10, without limitation.

At step 1110, method 1100 includes modifying a query. A query may be modified to rectified as described herein. In some embodiments, abbreviations of a query may be converted to full length form. This step may be implemented as described above with reference to FIGS. 1-10, without limitation.

At step 1115, method 1100 includes determining a context. A context of a query may be determined based on one or more keywords, phrases, semantic structures, and/or other textual data of a query. This step may be implemented as described above with reference to FIGS. 1-6, without limitation.

At step 1120, method 1100 includes determining a relevance. A relevance may be determined based on a determined context of a query. A relevance may include a determination of being relevant or a determination of not being relevant to one or more previously entered queries. This step may be implemented as described above with reference to FIGS. 1-10, without limitation.

At step 1125, method 1100 includes adapting a correct query. A corrected query may be adapted to expand upon identified relevant context.

At step 1130, method 1100 includes receiving a plurality of documents. A plurality of documents may be received via user input and/or external computing devices. A plurality of documents may be any type of document, without limitation.

At step 1135, method 1100 includes parsing a plurality of documents. A plurality of documents may be parsed to identify one or more structures of each document of a plurality of documents. Structures may include, but are not limited to, headers, body paragraphs, lists, footers, tables, images, and/or other parts of a document.

At step 1140, method 1100 includes converting hierarchical structures into one or more data chunks. For instance, a single document may be broken up into one or more data chunks based on one or more identified structures of the document.

At step 1145, method 1100 includes retrieving one or more data chunks. Data chunks may be retrieved based on a determined relevance to a query. Data chunks may be retrieved through a hybrid retrieval process.

At step 1150, method 1100 includes providing a response. A response may be generated based on a query and one or more data chunks by a gen A I model.

The steps described above may be implemented as described above with reference to FIGS. 1-10, without limitation.

### Machine Learning and Computing Systems

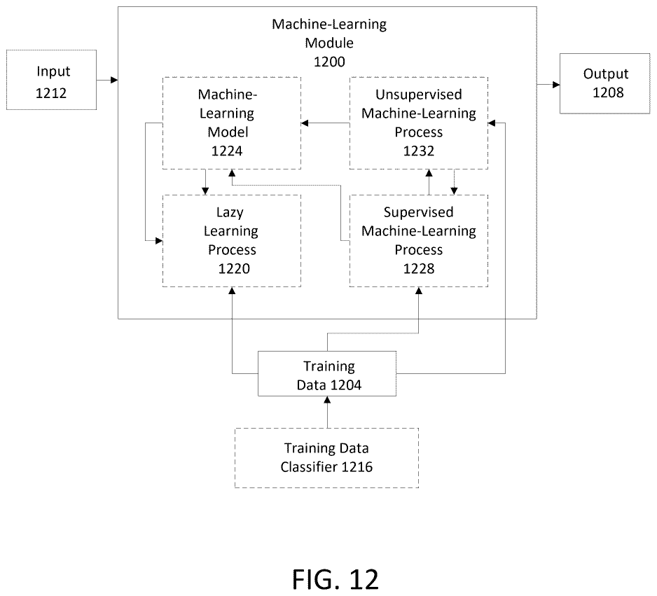

Referring to FIG. 12, an exemplary machine-learning module 1200 may perform machine-learning process(es) and may be configured to perform various determinations, calculations, processes and the like as described herein using one or more machine-learning processes.

Machine learning module 1200 may utilize training data 1204. For instance, and without limitation, training data 1204 may include a plurality of data entries, each entry representing a set of data elements that were recorded, received, and/or generated together. Training data 1204 may include data elements that may be correlated by shared existence in a given data entry, by proximity in a given data entry, or the like. Multiple data entries in training data 1204 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1204 according to various correlations. Correlations may indicate causative and/or predictive links between categories of data elements, which may be modeled as relationships such as mathematical relationships by machine-learning processes as described in further detail below. Training data 1204 may be formatted and/or organized by categories of data elements. Training data 1204 may, for instance, be organized by associating data elements with one or more descriptors corresponding to categories of data elements. As a non-limiting example, training data 1204 may include data entered in standardized forms by one or more individuals, such that entry of a given data element in a given field in a form may be mapped to one or more descriptors of categories. Elements in training data 1204 may be linked to descriptors of categories by tags, tokens, or other data elements. Training data 1204 may be provided in fixed-length formats, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 12, training data 1204 may include one or more elements that are not categorized. Uncategorized data of training data 1204 may include data that may not be formatted or containing descriptors for some elements of data. In some embodiments, machine-learning algorithms and/or other processes may sort training data 1204 according to one or more categorizations. Machine-learning algorithms may sort training data 1204 using, for instance, natural language processing algorithms, tokenization, detection of correlated values in raw data and the like. In some embodiments, categories of training data 1204 may be generated using correlation and/or other processing algorithms. As a non-limiting example, in a body of text, phrases making up a number “n” of compound words, such as nouns modified by other nouns, may be identified according to a statistically significant prevalence of n-grams containing such words in a particular order. For instance, an n-gram may be categorized as an element of language such as a “word” to be tracked similarly to single words, which may generate a new category as a result of statistical analysis. In a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries in an automated fashion may enable the same training data 1204 to be made applicable for two or more distinct machine-learning algorithms as described in further detail below. Training data 1204 used by machine-learning module 1200 may correlate any input data as described in this disclosure to any output data as described in this disclosure, without limitation.

Further referring to FIG. 12, training data 1204 may be filtered, sorted, and/or selected using one or more supervised and/or unsupervised machine-learning processes and/or models as described in further detail below. In some embodiments, training data 1204 may be classified using training data classifier 1216. Training data classifier 1216 may include a classifier. A “classifier” as used in this disclosure is a machine-learning model that sorts inputs into one or more categories. Training data classifier 1216 may utilize a mathematic AI model, an artificial neural network, or a program generated by a machine learning algorithm. A machine learning algorithm of training data classifier 1216 may include a classification algorithm. A “classification algorithm” as used herein is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine-learning module 1200 may generate a classifier, such as training data classifier 1216 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1216 may classify elements of training data to one or more parameters of a gen AI responses and/or response templates.

Still referring to FIG. 12, machine-learning module 1200 may be configured to perform a lazy-learning process 1220 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1204. Heuristic may include selecting some number of highest-ranking associations and/or training data 1204 elements. Lazy learning may implement any suitable lazy learning algorithm, including without limitation a K-nearest neighbors algorithm, a lazy naive Bayes algorithm, or the like. Persons skilled in the art, upon reviewing the entirety of this disclosure, will be aware of various lazy-learning algorithms that may be applied to generate outputs as described herein, including lazy learning applications of machine-learning algorithms as described in further detail below.

Still referring to FIG. 12, machine-learning processes as described herein may be used to generate machine-learning models 1224. A “machine-learning model” as used herein is a mathematical and/or algorithmic representation of a relationship between inputs and outputs, as generated using any machine-learning process including without limitation any process as described above, and stored in memory. For instance, an input may be sent to machine-learning model 1224, which once created, may generate an output as a function of a relationship that was derived. For instance, and without limitation, a linear regression model, generated using a linear regression algorithm, may compute a linear combination of input data using coefficients derived during machine-learning processes to calculate an output. As a further non-limiting example, machine-learning model 1224 may be generated by creating an artificial neural network, such as a convolutional neural network comprising an input layer of nodes, one or more intermediate layers, and an output layer of nodes. Connections between nodes may be created via the process of “training” the network, in which elements from a training data 1204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 12, machine-learning algorithms may include supervised machine-learning process 1228. A “supervised machine learning process” as used herein is one or more algorithms that receive labelled input data and generate outputs according to the labelled input data. For instance, supervised machine learning process 1228 may include entity data as described above as inputs, deterioration metrics as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 1204. Persons skilled in the art, upon reviewing the entirety of this disclosure, will be aware of various possible variations of at least a supervised machine-learning process 1228 that may be used to determine relation between inputs and outputs. Supervised machine-learning processes may include classification algorithms as defined above.

Further referring to FIG. 12, machine learning processes may include unsupervised machine-learning processes 1232. An “unsupervised machine-learning process” as used herein is a process that calculates relationships in one or more datasets without labelled training data. Unsupervised machine-learning process 1232 may be free to discover any structure, relationship, and/or correlation provided in training data 1204. Unsupervised machine-learning process 1232 may not require a response variable. Unsupervised machine-learning process 1232 may calculate patterns, inferences, correlations, and the like between two or more variables of training data 1204. In some embodiments, unsupervised machine-learning process 1232 may determine a degree of correlation between two or more elements of training data 1204.

Still referring to FIG. 12, machine-learning module 1200 may be designed and configured to create a machine-learning model 1224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model. Linear regression models may be generalized in an embodiment to polynomial regression models, whereby a polynomial equation (e.g. a quadratic, cubic or higher-order equation) providing a best predicted output/actual output fit is sought. Similar methods to those described above may be applied to minimize error functions, according to some embodiments. In some embodiments, machine learning model 1224 may utilize one or more encoders and/or decoders, transformer architectures, attention mechanisms, self-attention mechanisms, multi-head attention, masked multi-head attention, token biasing, probability biasing, feed forward layers, positional encoding, recurrent decoders, or any other processes that may be implemented.

Continuing to refer to FIG. 12, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes, such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

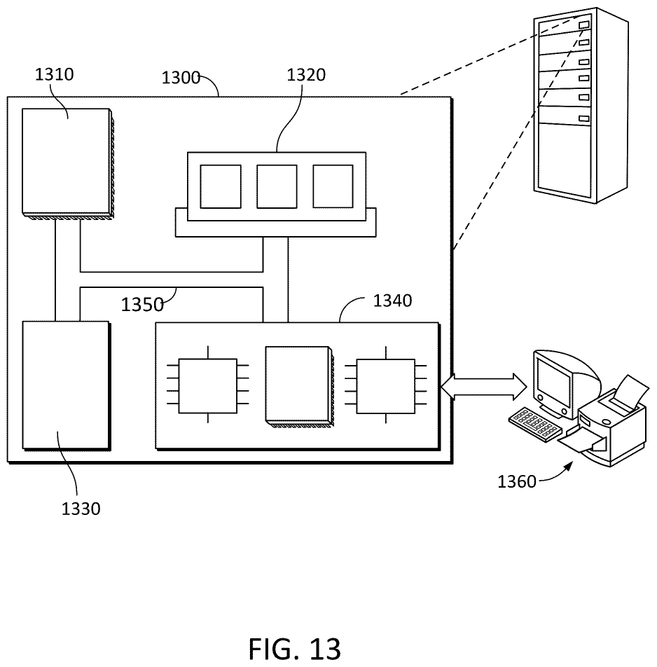

FIG. 13 is a block diagram of an example computer system 1300 that may be used in implementing the technology described in this document. General-purpose computers, network appliances, mobile devices, or other electronic systems may also include at least portions of the system 1300. The system 1300 includes a processor 1310, a memory 1320, a storage device 1330, and an input/output device 1340. The apparatus may include disk storage and/or internal memory, each of which may be communicatively connected to each other. The apparatus 1300 may include a processor 1310. The processor 1310 may enable both generic operating system (OS) functionality and/or application operations. In some embodiments, the processor 1310 and the memory 1320 may be communicatively connected. As used in this disclosure, “communicatively connected” means connected by way of a connection, attachment, or linkage between two or more elements which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween.

Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device.

Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 1310 may include any computing device as described in this disclosure, including without limitation a microcontroller, microprocessor, digital signal processor (DSP) and/or system on a chip (SoC) as described in this disclosure. The processor 1310 may include, be included in, and/or communicate with a mobile device such as a mobile telephone or smartphone. The processor 1310 may include a single computing device operating independently, or may include two or more computing device operating in concert, in parallel, sequentially or the like. Two or more computing devices may be included together in a single computing device or in two or more computing devices. The processor 1310 may interface or communicate with one or more additional devices as described below in further detail via a network interface device. Network interface device may be utilized for connecting the processor 1310 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

The processor 1310 may include but is not limited to, for example, a computing device or cluster of computing devices in a first location and a second computing device or cluster of computing devices in a second location. The processor 1310 may include one or more computing devices dedicated to data storage, security, distribution of traffic for load balancing, and the like. The processor 1310 may distribute one or more computing tasks as described below across a plurality of computing devices of computing device, which may operate in parallel, in series, redundantly, or in any other manner used for distribution of tasks or memory between computing devices. The processor 1310 may be implemented using a “shared nothing” architecture in which data is cached at the worker, in an embodiment, this may enable scalability of system 1300 and/or processor 1310.

With continued reference to FIG. 13, processor 1310 and/or a computing device may be designed and/or configured by memory 1320 to perform any method, method step, or sequence of method steps in any embodiment described in this disclosure, in any order and with any degree of repetition. For instance, the processor 1310 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 1310 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Each of the components 1310, 1320, 1330, and 1340 may be interconnected, for example, using a system bus 1350. The processor 1310 is capable of processing instructions for execution within the system 1300. In some implementations, the processor 1310 is a single-threaded processor. In some implementations, the processor 1310 is a multi-threaded processor. In some implementations, the processor 1310 is a programmable (or reprogrammable) general purpose microprocessor or microcontroller. The processor 1310 is capable of processing instructions stored in the memory 1320 or on the storage device 1330.

The memory 1320 stores information within the system 1300. In some implementations, the memory 1320 is a non-transitory computer-readable medium. In some implementations, the memory 1320 is a volatile memory unit. In some implementations, the memory 1320 is a non-volatile memory unit.

The storage device 1330 is capable of providing mass storage for the system 1300. In some implementations, the storage device 1330 is a non-transitory computer-readable medium. In various different implementations, the storage device 1330 may include, for example, a hard disk device, an optical disk device, a solid-date drive, a flash drive, or some other large capacity storage device. For example, the storage device may store long-term data (e.g., database data, file system data, etc.). The input/output device 1340 provides input/output operations for the system 1300. In some implementations, the input/output device 1340 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 1360. In some examples, mobile computing devices, mobile communication devices, and other devices may be used.

1. A computer-implemented method for generating complete and contextually accurate responses in a retrieval-augmented generation system using a pretrained generative artificial intelligence (AI) model, comprising:
receiving a query associated with a user;
determining a context of the query based on a prior conversational history of the user with the pretrained generative AI model;
determining a relevance of the query to a current conversation of the user with the pretrained generative AI model based on the context of the query;
modifying the query based on the determined relevance;
parsing a plurality of electronic documents to identify hierarchical structures of each electronic document of the plurality of electronic documents, wherein identifying the hierarchical structures comprises creating a path that links a chain of headers in each electronic document in a hierarchical order;
converting the hierarchical structures into one or more plurality of data chunks based on content within the hierarchical structures;
retrieving one or more of the plurality of data chunks based on the modified query by identifying and retrieving the data chunks that share the path;
providing the modified query and the retrieved one or more data chunks as input to the pretrained generative AI model; and
receiving as output from the pretrained generative AI model a response based at least in part on the modified query and the retrieved one or more data chunks.

2. The method of claim 1, further comprising:
receiving from the pretrained generative AI model one or more partial responses; and
consolidating the one or more partial responses into a single comprehensive response.

3. The method of claim 1, wherein retrieving the one or more of the plurality of data chunks comprises using a hybrid retrieval process.

4. The method of claim 3, wherein the hybrid retrieval process comprises both a keyword search and a semantic search.

5. The method of claim 4, further comprising consolidating results from both the keyword search and the semantic search by applying weightages to the results to prioritize results of the semantic search.

6. The method of claim 5, further comprising selecting a subset of the one or more plurality of data chunks based on selection criteria.

7. The method of claim 6, further comprising:
identifying a unique header of each data chunk of the subset of the one or more plurality of data chunks; and
retrieving all data chunks sharing the unique header.

8. The method of claim 1, further comprising modifying the query through one or more of rectification and expansion of the query to provide a corrected query.

9. The method of claim 1, further comprising formatting the response based on the modified query.

10. The method of claim 1, further comprising embedding a path of one or more hierarchical structures into metadata of at least one data chunk.

11. The method of claim 10, further comprising retrieving the one or more of the plurality of data chunks based on the embedded path of the one or more hierarchical structures of the at least one data chunk.

12. The method of claim 1, further comprising embedding the modified query into a vector representation of a vector database.

13. The method of claim 1, further comprising:
generating an example through the pretrained generative AI based on the query; and
consolidating the example into the response generated by the pretrained generative AI.

14. The method of claim 1, further comprising:
identifying images within each electronic document; and
storing references to the images within meta data of the one or more plurality of data chunks.

15. The method of claim 14, further comprising:
identifying a non-essential image of an electronic document based on a size threshold; and
omitting meta data of the non-essential image from the one or more plurality of data chunks.

16. The method of claim 1, further comprising:
identifying headers and/or footers of an electronic document exceeding a threshold region; and
omitting the headers and/or footers of the electronic document from the one or more plurality of data chunks based on the threshold region.

17. The method of claim 1, further comprising:
identifying tables within an electronic document of the plurality of electronic documents exceeding a threshold value;
splitting the tables into one or more data chunks based on the threshold value; and
generating header paths for each of the one or more data chunks corresponding to the tables.

18. An apparatus for generative artificial intelligence (AI) query processing, comprising:
a processor and a memory communicatively coupled to the processor, the memory containing instructions configuring the processor to:
receive a query associated with a user;
modify the query through one or more of rectification and expansion of the query to provide a corrected query;
determine a context of the corrected query based on a prior conversational history of the user with a pretrained generative AI model;
determine a relevance of the corrected query to a current conversation of the user with the pretrained generative AI model based on the context of the corrected query;
adapt the corrected query based on the determined relevance;
parse a plurality of electronic documents to identify hierarchical structures of each electronic document of the plurality of electronic documents, wherein identifying the hierarchical structures comprises creating a path that links a chain of headers in each electronic document in a hierarchical order;
convert the hierarchical structures into one or more plurality of data chunks based on content within the hierarchical structures;
retrieve one or more of the plurality of data chunks based on the modified query by identifying and retrieving the data chunks that share the path; and
provide the corrected query and the retrieved one or more data chunks as input to the pretrained generative AI model.

19. The apparatus of claim 18, wherein rectification of the query includes correcting grammatical errors of the query.

20. The apparatus of claim 18, wherein expansion of the query includes converting abbreviations of the query to full length forms.

21. The apparatus of claim 18, wherein the prior conversational history includes at least one pair of a previous query and response used by the generative AI model.

22. The apparatus of claim 18, wherein the corrected query is adapted by revising the query to include relevant context from one or more previous conversational histories with a user and the generative AI model.

23. A system for data retrieval in a generative artificial intelligence (AI) model, comprising:
a computing device comprising a processor and a memory communicatively coupled to the processor, the computing device configured to:
receive a plurality of documents;
parse the plurality of documents to identify hierarchical structures of each document of the plurality of documents, wherein identifying the hierarchical structures comprises creating a path that links a chain of headers in each electronic document in a hierarchical order;
convert the hierarchical structures into one or more plurality of data chunks based on content of the identified hierarchical structures;
retrieve, based on a query, the one or more of the plurality of data chunks by identifying and retrieving the data chunks that share the path; and
provide the retrieved one or more data chunks as input to a pretrained generative AI model.

24. The system of claim 23, wherein each hierarchical structure is assigned a level corresponding to content importance.

25. The system of claim 23, wherein the computing device is further configured to embed the path of one or more hierarchical structures into metadata of at least one data chunk.
